(19) United States
(12) Patent Application Publication
(10) Pub. No.: US 2024/0099366 A1
(43) Pub. Date: Mar. 28, 2024

(54) CASE FOR AN AEROSOL DELIVERY DEVICE

(71) Applicant: Nicoventures Trading Limited, LONDON (GB)

(72) Inventor: Mohsin MASIH-UD-DIN, London (GB)

(21) Appl. No.: 18/257,427

(22) PCT Filed: Dec. 13, 2021
(86) PCT No.: PCT/GB2021/053260

§ 371 Date: Jun. 14, 2023

(30) Foreign Application Priority Data
Dec. 14, 2020 (GB) 2019675.4

(51) Int. Cl. A24F 15/01; A45C 11/00; H04M 1/72412

(52) U.S. Cl. CPC A24F 15/01; A45C 11/008; H04M 1/72412; A45C 2200/05

(57) ABSTRACT

A case for an aerosol delivery device and a method for using the case is described and can include a lid having an open position and a closed position; and a communications module for providing two-way communications with a user device or remote application, wherein the communication module communicates a change in the lid position to the user device or remote application and receives instructions relating to the operation of the case from the user device or remote application.

### PRIORITY CLAIM

The present application is a National Phase Entry of PCT Application No. PCT/GB2021/053260, filed Dec. 13, 2021, which claims priority from GB Application No. 2019675.4, filed Dec. 14, 2020, each of which are hereby fully incorporated by reference.

### TECHNICAL FIELD

The present specification relates to a case (e.g. a carry case), in particular a case for an aerosol delivery device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol delivery device may be provided with a case for retaining the device when not in use. There remains a need for further developments in this field.

### SUMMARY

In a first aspect, this specification describes a case for an aerosol delivery device (which aerosol delivery device may, for example, comprise a tobacco heating system), the case comprising: a lid having an open position and a closed position; and a communications module for providing two-way communications with a user device or remote application, wherein the communication module communicates a change in the lid position to the user device or remote application and receives instructions relating to the operation of the case from the user device or remote application. The change in the lid position may, for example, be indicated by a sensor, such as a switch.

The case may further comprise a locking mechanism for preventing the case from being opened in response to an instruction from the user device or remote application.

The case may further comprise a control module. The control module may be configured to activate or deactivate the case in response to a control signal from the user device or remote application. Alternatively, or in addition, the control module may be configured to pair the case with an individual user device or remote application such that the communications module communicates only with the paired user device or remote application.

The aerosol delivery device may, for example, be a non-combustible aerosol provision device.

The case may further comprise the aerosol delivery device.

The aerosol delivery device may be configured to receive a removable article comprising an aerosolizable material. The aerosolizable may comprise an aerosol generating substrate and an aerosol forming material.

In a second aspect, this specification describes an application (e.g. a remote application, such as an application stored on a user device) comprising: a first input for receiving an indication of a position of a lid of a case for an aerosol delivery device, the case being under the control of the application, wherein the lid has an open position and a closed position; a first output configured to provide information regarding the position of the lid to a user (e.g. a user of the application and the case); a second input for receiving instructions relating to the operation of the case from the user; and a second output for communicating the received instructions to the case.

The received instructions may comprise instructions relating to a desired locking status of the case. Alternatively, or in addition, the received instructions may include activation or deactivation instructions for said case. Alternatively, or in addition, the received instructions may include pairing instruction for pairing the application with the case such that the case communicates only with the paired user device or remote application.

In a third aspect, this specification describes a method comprising: receiving a signal indicative of whether a lid of a case for an aerosol delivery device is in an open position or a closed position; communicating a change in the lid position to a user device or remote application; and receiving instructions relating to the operation of the case from the user device or remote application. The method of the third aspect may be implemented at a communication module or a control module of the case for the aerosol delivery system.

The method may comprise receiving a locking signal from the user device or remote application indicating a desired locking status of the case and controlling a locking mechanism of the case accordingly. Alternatively, or in addition, the method may comprise activating or deactivating the case in response to a control signal from the user device or remote application. Alternatively, or in addition, the method may comprise pairing the case with an individual user device or remote application.

The method may comprise receiving the aerosol delivery device within the case.

In a fourth aspect, this specification describes a method comprising: receiving an indication of a position of a lid of a case of an aerosol delivery device, wherein the lid has an open position and a closed position; providing information regarding the position of the lid to a user; receiving instructions relating to an operation of the case from the user; and communicating the received instructions to the case. The method of the fourth aspect may be implemented at a remote user device or at an application (e.g. an application on a remote user device).

The received instructions may comprise instructions relating to one or more of: a desired locking status of the case; activation or deactivation instructions for said case; and pairing the application with the case such that the case communicates only with the paired user device or remote application.

In a fifth aspect, this specification describes a kit of parts comprising a case as described above with reference to the first aspect, an aerosol delivery device and an article for use in the aerosol delivery device. The aerosol delivery device may be a non-combustible aerosol provision device. The article may be a removable article comprising an aerosol generating material.

### BRIEF DESCRIPTION OF THE DRAWINGS

Example embodiments will now be described, by way of example only, with reference to the following schematic drawings, in which:

FIG. 1 shows a case for an aerosol delivery device in accordance with an example embodiment.

FIG. 2 is a block diagram of a non-combustible aerosol provision device in accordance with an example embodiment.

FIG. 3 is a flow chart showing an algorithm in accordance with an example embodiment.

FIGS. 4 and 5 are block diagrams of systems in accordance with example embodiments.

FIGS. 6 and 7 are flow charts showing algorithms in accordance with example embodiments.

FIG. 8 is a block diagram of a system in accordance with an example embodiment.

FIGS. 9 and 10 shows displays of a user device or application in accordance with example embodiments.

### DETAILED DESCRIPTION

As used herein, the term “aerosol delivery device” is intended to encompass systems that deliver a substance to a user, and includes:
non-combustible aerosol provision systems that release compounds from an aerosolizable material without combusting the aerosolizable material, such as electronic cigarettes, tobacco heating products, and hybrid systems to generate aerosol using a combination of aerosolizable materials; and
articles comprising aerosolizable material and configured to be used in one of these non-combustible aerosol provision systems.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

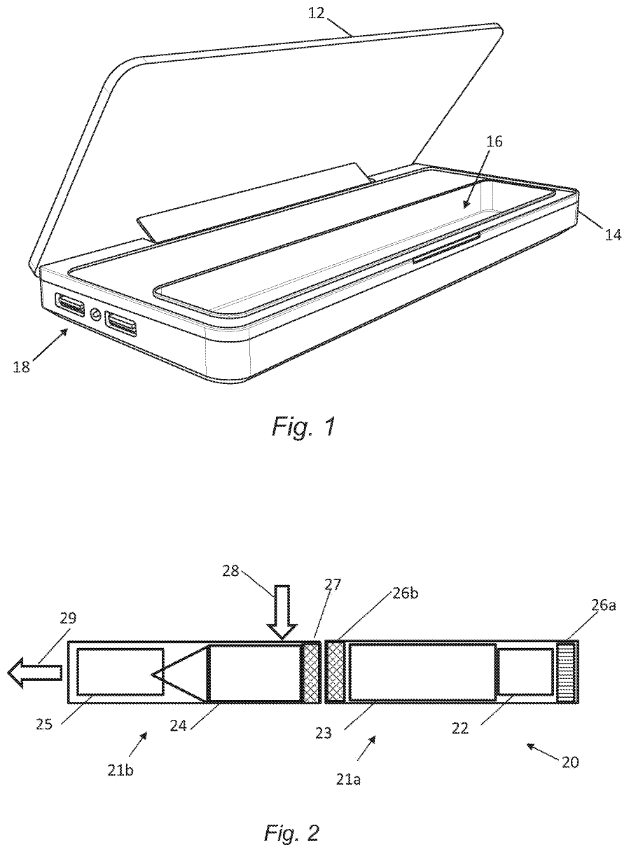

FIG. 1 shows a case for an aerosol delivery device, indicated generally by the reference numeral 10, in accordance with an example embodiment. The case 10 comprises a lid 12 and a main body 14. The main body 14 includes a storage area 16 for storing an aerosol delivery device (not shown in FIG. 1). The aerosol delivery device may be a non-combustible aerosol provision device, although this is not essential to all example embodiments.

The case 10 includes a port 18 that may be used for charging a battery of an aerosol delivery device stored in the storage area 16.

FIG. 2 is a block diagram of a non-combustible aerosol provision device, indicated generally by the reference numeral 20, in accordance with an example embodiment. The aerosol delivery device may be stored within the area 16 of the case 10 described above. The device 20 is a modular device, comprising a first part 21a and a second part 21b. In some embodiments, the first part 21a and the second part 21b may be stored separately in the case 10 (e.g. detached from one another). The aerosol delivery device 20 may comprise a tobacco heating system.

The first part 21a of the device 20 includes a control circuit 22 and a battery 23. The second part 21b of the device 20 includes a heater 24 and a liquid reservoir 25 (that may collectively form an aerosol generator).

The first part 21a includes a first connector 26a (such as a USB connector). The first connector 26a may enable connection to be made to a power source (e.g. a battery of the case 10 or an external power supply via the port 18 of the case 10) for charging the battery 23, for example under the control of the control circuit 22.

The first part 21a also includes a second connector 26b that can be removably connected to a first connector 27 of the second part 21b.

In the use of the device 20, air is drawn into an air inlet of the heater 24, as indicated by the arrow 28. The heater is used to heat the air (e.g. under the control of the circuit 23). The heated air is directed to the liquid reservoir 25, where an aerosol is generated. The aerosol exits the device at an air outlet, as indicated by the arrow 29 (for example into the mouth of a user of the device 20).

The liquid reservoir 25 may be provided by a removable article comprising an aerosolizable material. The aerosolizable material may comprise an aerosol generating substrate and an aerosol forming material.

It should be noted that the device 20 is described by way of example only. Many alternative devices could be stored within the case 10 in accordance with example embodiments.

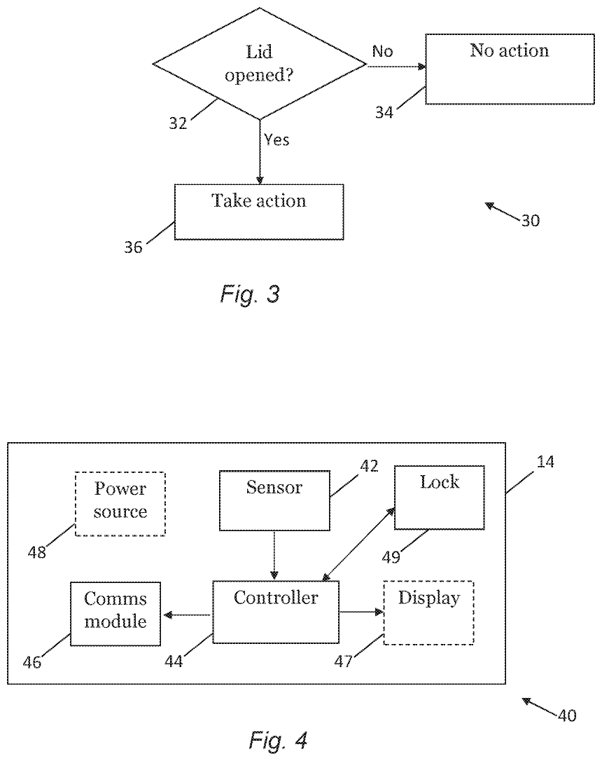

FIG. 3 is a flow chart showing an algorithm, indicated generally by the reference numeral 30, in accordance with an example embodiment.

The algorithm 30 starts at operation 32, where a determination is made regarding whether the lid 12 of the case 10 has been opened. If not, the algorithm 30 moves to operation 34 where no action is taken. The algorithm 30 may then terminate, or may return to the operation 32.

If it is determined in the operation 32 that the lid has been opened, then the algorithm 30 moves to operation 36 where action is taken in response to the opening of the lid. Example actions are discussed further below.

Of course, the algorithm 30 shown in FIG. 3 is highly schematic and may be implemented in many different ways. For example, the algorithm 30 may be implemented as an interrupt routine, wherein the detection of the lid changing from a closed state to the opened state triggers the operation 36 (where action is taken).

FIG. 4 is a block diagram of a system, indicated generally by the reference numeral 40, in accordance with an example embodiment.

The system 40 comprises a sensor 42, a controller 44, a communications module 46, a display 47, a power source 48 and a locking mechanism 49 provided with the main body 14 of the case 10. The display 47 and the power source 48 are shown in dotted form as one or both of those modules may be omitted in some example embodiments, although it should be noted that other modules may be omitted in some example embodiments.

The sensor 42 provides a signal to the controller 44 indicative of whether the lid is open or closed. A switch that may be used to implement the sensor 42 is described below but, of course, many alternatives (such as the use of a hall sensor/magnet pair) are possible.

The power source 48 (such as a battery) may provide power to the various elements within the main body of the case 10 (such as the controller 44, the communication module 46 and the display 47). In some example embodiments, the battery 23 of an aerosol delivery device 20 mounted within the storage area 16 of the case 10 may be used to power the elements within the main body of the case in addition to, or instead of, the power source 48. Indeed in some example embodiments, the power source 48 may be omitted.

As discussed in detail below, the controller 44 is configured to control the communication module 46 and/or the display 47. Note that in some example embodiments, the display 47 may be omitted.

The controller 44 also controls the locking mechanism 49 such that the lid of the case can be locked under the control of the controller 44. By way of example, a electromagnetic locking mechanism may be provided, although, of course, the skilled person will be aware of many alternative embodiments. As discussed below, the controller 44 may control the locking mechanism 49 based, at least in part, on a signal received from a user via the communications module 46.

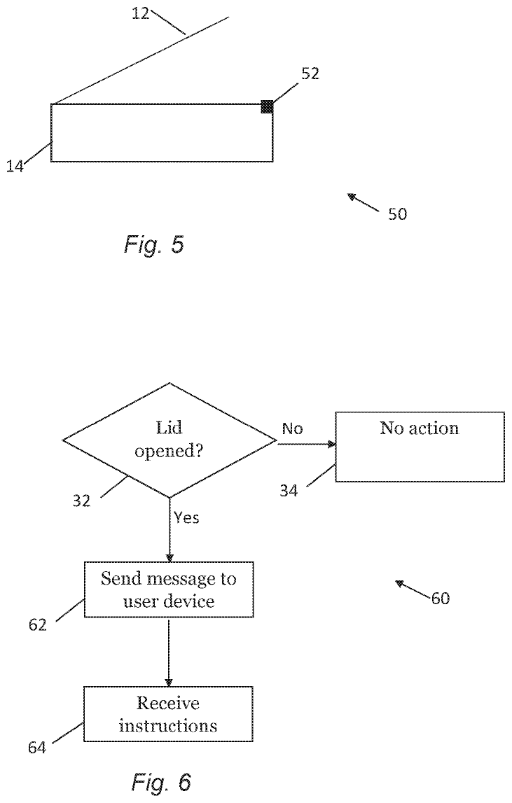

FIG. 5 is a block diagram of a system, indicated generally by the reference numeral 50, in accordance with an example embodiment.

The system 50 shows the lid 12 and the main body 14 of the case described above. The system 50 also shows a switch 52 that is used to determine when the lid 12 is opened or closed. The switch 52 is one example of many arrangements for determining whether the lid 12 is opened or closed (thereby providing the functionality of the sensor 42 described above). Other examples include a magnet/hall sensor pairs or the detection of an impedance change. The skilled person will be aware of many alternative arrangements that could be used.

FIG. 6 is a flow chart showing an algorithm, indicated generally by the reference numeral 60, in accordance with an example embodiment.

The algorithm 60 starts at operation 32, where, as discussed above, a determination is made regarding whether the lid 12 of the case 10 has been opened. That determination may be made by the controller 44, based on the output of the sensor 42. If not, the algorithm 60 moves to operation 34 where no action is taken. The algorithm 30 may then terminate, or may return to the operation 32.

If it is determined in the operation 32 that the lid has been opened, then the algorithm 60 moves to operation 62 where a message is sent to a user device or a remote application. The user device or remote application may be paired with the case 10. For example, a user may synchronize/pair an application of their mobile phone with the case 10, such that status information can be provided to the application when the case is opened. The communication may be implementing using a range of mobile communication technologies, such as Bluetooth, wi-fi, etc.

At operation 64 of the algorithm 60, instructions are received (e.g. from a paired user device or remote application) relating to the operation of the case. For example, a user may provide instructions regarding the operation of the case in response to the message received in the operation 62.

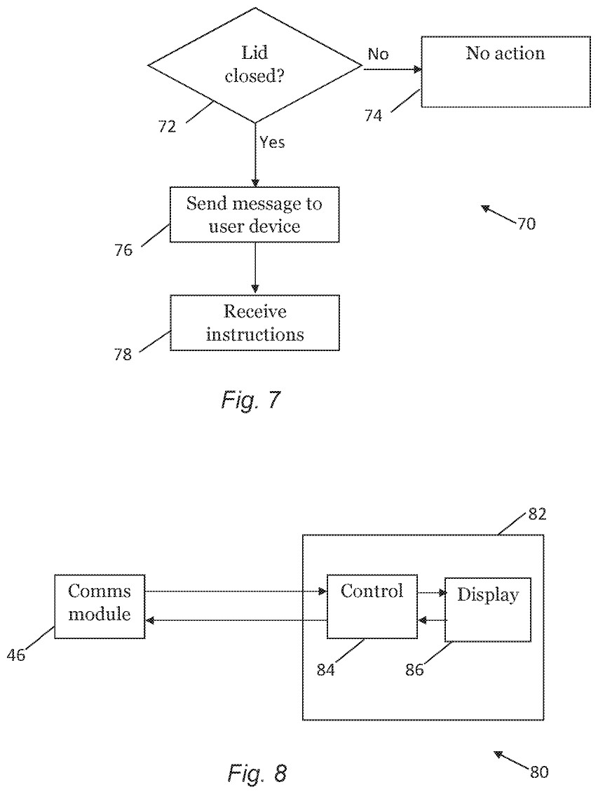

As described above, actions may be triggered when an opening of the lid is detected. Alternatively, or in addition, actions may be triggered when a closing of the lid is detected. By way of example, FIG. 7 is a flow chart showing an algorithm, indicated generally by the reference numeral 70, in accordance with an example embodiment.

The algorithm 70 starts at operation 72, where a determination is made regarding whether the lid 12 of the case 10 has been closed. If not, the algorithm 40 moves to operation 74 where no action is taken (and the algorithm 70 may terminate).

If it is determined in the operation 72 that the lid has been closed, then the algorithm 70 moves to operation 76 where a message is sent to the user device or remote application (such that the operation 76 is similar to the operation 62 described above). Then, at operation 78 of the algorithm 70, instructions are received (e.g. from a paired user device or remote application) relating to the operation of the case. For example, a user may provide instructions regarding the operation of the case in response to the message received in the operation 76.

Of course, the algorithms 60 and 70 shown in FIGS. 6 and 7 are highly schematic and may be implemented in many different ways. For example, the algorithms 60 and 70 may be implemented as interrupt routines, wherein the detection of the lid changing from a closed state to the opened state or vice-versa triggers the sending of the message. Moreover, the sending of the message may be triggered when the lid is opened (algorithm 60), when the lid is closed (algorithm 70) or both.

FIG. 8 is a block diagram of a system, indicated generally by the reference numeral 80, in accordance with an example embodiment. The system 80 comprises the communication module 46 described above and further comprises a user device (or remote application) 82. The user device 82 includes a control module 84 and a display 86.

The messages sent in the operations 62 and 76 described above may be sent from the communication module 46 to the control module 84 of the user device 82. The control module 84 may determine whether and how to display the message to a user using the display 86.

A user may also provide input, such as instructions, using the display 86 (or in some other way), which input is provided to the control module 84. The control module 84 can then provide user instructions to the communication module 46, thereby establishing two-way communications between the controller 44 and the control module 84.

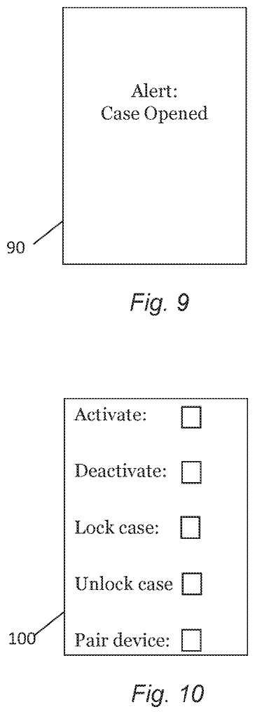

FIG. 9 shows a display, indicated by the reference numeral 90, of a user device or application in accordance with an example embodiment. The display 90 is an example output of the display 86 described above.

The display 90 provide a simple message a user: “Alert: Case Opened”. By way of example, the message may be displayed in response to the receipt, by an application, of the message sent by the operation 62 of the algorithm 60. The message 90 may be useful to a user in the event that the user is not in possession of the case. For example, a user may have left their case at home and the message may alert the user to a potential opening of the case by a third party.

FIG. 10 shows a display, indicated by the reference numeral 100, of a user device or application in accordance with an example embodiment. The display 100 is an example output of the display 86 described above. The display 100 shows examples of control inputs that might be made available to a user, for example via an application.

The example control inputs shown in the display 100 are:
Activate. The device may be activated by the user.
Deactivate. The device may be deactivated. For example, a user might want to deactivate the device to save power, or in the event that they are not in possession of the device.
Lock case. This feature might be particularly useful if the user is not in possession of the device and might want to prevent others from opening the case.
Unlock case.
Pair device. Pairing a user device or an application with the case may enable the case to communicates only with the paired user device or remote application.

The inputs provided above are examples. Some or all of the example control inputs described above may be omitted and further control inputs described above may be provided.

Messages may be sent to a remote application or user device for many other reasons in addition to, or instead of, the examples provided above. For example, if an unexpected event occurs, such as a failure to charge the device or a fault is detected, the user may be alerted.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the claims or limitations on equivalents to the claims, and that other embodiments may be utilized and modifications may be made without departing from the scope of the claims. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A case for an aerosol delivery device, the case comprising:
a lid having an open position and a closed position; and
a communications module for providing two-way communications with a user device or a remote application, wherein the communications module communicates a change in the lid position to the user device or the remote application and receives instructions relating to operation of the case from the user device or the remote application.

2. The case as claimed in claim 1, further comprising:
a locking mechanism for preventing the case from being opened in response to an instruction from the user device or the remote application.

3. The case as claimed in claim 1, further comprising a control module.

4. The case as claimed in claim 3, wherein the control module is configured to activate or deactivate the case in response to a control signal from the user device or the remote application.

5. The case as claimed in claim 3, wherein the control module is configured to pair the case with an individual user device or a remote application such that the communications module communicates only with the paired user device or the paired remote application.

6. The case as claimed in claim 1, wherein the aerosol delivery device is a non-combustible aerosol provision device.

7. The case as claimed in claim 1, further comprising the aerosol delivery device.

8. The case as claimed in claim 1, wherein the aerosol delivery device is configured to receive a removable article comprising an aerosolizable material.

9. The case as claimed in claim 8, wherein the aerosolizable material is present on a substrate.

10. The case as claimed in claim 1, wherein the aerosol delivery device comprises a tobacco heating system.

11. An application comprising:
a first input for receiving an indication of a position of a lid of a case for an aerosol delivery device, the case being under control of the application, wherein the lid has an open position and a closed position;
a first output configured to provide information regarding a position of the lid to a user;
a second input for receiving instructions relating to operation of the case from the user; and
a second output for communicating the received instructions to the case.

12. The application as claimed in claim 11, wherein the received instructions comprise instructions relating to a desired locking status of the case.

13. The application as claimed in claim 11, wherein the received instructions include activation or deactivation instructions for the case.

14. The application as claimed in claim 11, wherein the received instructions include pairing instruction for pairing the application with the case such that the case communicates only with a paired user device or a paired remote application.

15. A method comprising:
receiving a signal indicative of whether a lid of a case for an aerosol delivery device is in an open position or a closed position;
communicating a change in a lid position to a user device or a remote application; and
receiving instructions relating to operation of the case from the user device or the remote application.

16. The method as claimed in claim 15, further comprising:
receiving a locking signal from the user device or the remote application indicating a desired locking status of the case; and
controlling a locking mechanism of the case based on the locking signal.

17. The method as claimed in claim 15, further comprising activating or deactivating the case in response to a control signal from the user device or the remote application.

18. The method as claimed in claim 15, further comprising pairing the case with an individual user device or an individual remote application.

19. The method as claimed in claim 15, further comprising receiving the aerosol delivery device within the case.

20. A method comprising:
receiving an indication of a position of a lid of a case of an aerosol delivery device, wherein the lid has an open position and a closed position;
providing information regarding a position of the lid to a user;
receiving instructions relating to an operation of the case from the user; and
communicating the received instructions to the case.

21. The method as claimed in claim 20, wherein the received instructions comprise instructions relating to one or more of:
a desired locking status of the case;
activation or deactivation instructions for the case; or
pairing an application with the case such that the case communicates only with a paired user device or a paired remote application.

22. A kit of parts comprising a case as claimed in claim 1, an aerosol delivery device and an article for use in the aerosol delivery device.

23. The kit of parts as claimed in claim 22, wherein the aerosol delivery device is a non-combustible aerosol provision device.

24. The kit of parts as claimed in claim 22, wherein the article is a removable article comprising an aerosol generating material.
